(19) United States
(12) Patent Application Publication
(10) Pub. No.: US 2026/0100316 A1
(43) Pub. Date: Apr. 9, 2026

(54) ELECTRICAL SWITCH WITH SPRING SYSTEM

(71) Applicant: Diomedes AG, Schaffhausen (CH)

(72) Inventor: Marc CRUCIUS, Schaffhausen (CH)

(21) Appl. No.: 19/352,013

(22) Filed: Oct. 7, 2025

(30) Foreign Application Priority Data
Oct. 7, 2024 (EP) 24 204 903.9

(51) Int. Cl. H01H 3/38; H01H 9/02

(52) U.S. Cl. CPC H01H 3/38; H01H 9/02; H01H 2235/018

(57) ABSTRACT

The present disclosure comprises an electrical switch, in particular a medium voltage switch, comprising: an insulating housing, a mechanically operable switching device arranged in the housing, a switch rod which extends at least partially through a cavity within the housing for operating the switching device, a drive for actuating the switch rod, and a spring system. The spring system comprises a first spring and a second spring that are nested inside each other, with the first spring and the second spring exerting a force on the drive in opposite directions.

### CROSS REFERENCE TO RELATED APPLICATIONS

The present application claims priority to European Patent Application No. 24 204 903.9 filed on Oct. 7, 2024. The entire contents of the above-listed application are hereby incorporated by reference for all purposes.

### TECHNICAL FIELD

The present disclosure relates to an electrical switch with a spring system.

### BACKGROUND

In the prior art, there are numerous examples of electrical switches in which springs are used to actuate movable switch elements. Springs are also used in reclosers, which act as switches for switching operating and fault currents. They can be used, for example, to exert contact pressure on switch elements. Furthermore, reclosers are mainly used outdoors and in high-voltage environments, which is why the requirements for sealing and insulation properties are correspondingly high.

### SUMMARY

Publication EP 0 782 160 A2 shows an electrical switch with a diaphragm seal, wherein the switch is used in a high-voltage environment. The publication discloses a spring element that acts on a movable contact element in the closing direction. The spring element is integrated into a switch rod.

The present application for protection is generally directed to the technical field of electrical switches and is optionally used for the reclosers mentioned at the beginning.

The object of the present disclosure is to provide an electrical switch with a spring system that comprises improved product and manufacturing features compared to the prior art.

The present disclosure comprises, in a first aspect, an electrical switch with an insulating housing, a mechanically operable switching device arranged in the housing, a switch rod which extends at least partially through a cavity within the housing for operating the switching device, a drive for operating the switch rod, and a spring system. According to the disclosure, the spring system comprises a first and a second spring that are nested inside each other, with the first spring and the second spring exerting a force on the drive in opposite directions. Thus, the drive is supported by the spring system during both a closing operation and an opening operation, at least over part of the stroke. In addition, the nesting of the springs allows for a reduction in installation space.

In one possible configuration, the first spring supports the drive at least during movement from a first end position, which corresponds to a closed position of the switch. In one possible configuration, the second spring supports the drive at least during movement from a second end position, which corresponds to an open position of the switch. The first and second springs do not have to support the drive over the entire stroke.

In one possible configuration of the first aspect, the first spring acting on the drive in the opening direction is arranged at least partially within the second spring acting on the drive in the closing direction. This results in a particularly compact arrangement that takes into account the springs used.

In a possible configuration of the first aspect of the present disclosure, the switch comprises a flexible insulating body, for example a diaphragm, which connects the switch rod to an inner wall of the housing.

In a possible configuration of the first aspect of the present disclosure, the spring system is at least partially arranged in the cavity of the housing.

In one possible configuration of the first aspect of the present disclosure, the spring system is arranged on a side of the insulating body facing away from the switching device.

However, such a configuration is also the subject of the present disclosure, independently of the features of the first aspect and, in particular, independently of the specific configuration of the spring system.

The present disclosure therefore comprises, in a second independent aspect, an electrical switch with an insulating housing, a mechanically actuable switching device arranged in the housing, a switch rod which extends at least partially through a cavity within the housing for actuating the switching device, a flexible insulating body, for example a diaphragm, which connects the switch rod to an inner wall of the housing, a drive for actuating the switch rod, and a spring system. According to the second aspect, the spring system is arranged at least partially in the cavity of the housing. This provides a compact design with an improved insulation concept.

In one possible configuration, the spring system according to the second aspect may comprise only a single spring, which prestresses the drive in the opening direction or in the closing direction.

However, the spring system according to the second aspect optionally comprises a first spring and a second spring, which are optionally nested inside each other.

Furthermore, the second aspect of the present disclosure according to claim 3 is optionally used in a switch according to the aspect corresponding to claim 1 of the present disclosure.

Exemplary configurations of the present disclosure, which further develop each of the two aspects individually, are described below.

In one possible configuration of the present disclosure, the drive is arranged on the external side of a cover element, through which the cavity of the housing is at least partially closed, wherein the spring system is arranged in a region between the cover element and the flexible insulating body.

In one possible configuration of the present disclosure, an axially inner end of the first spring and/or the second spring is axially supported on one or more fastening surfaces that are in rigid connection with the switch rod.

In one possible configuration of the present disclosure, an axially outer end of the second spring acting on the drive in the closing direction is axially supported on the housing.

In one possible configuration, this is achieved by means of a retaining member connected to the housing. Optionally, the retaining member is a cover element through which the cavity of the housing is at least partially closed.

In one possible configuration of the present disclosure, an axially outer end of the first spring acting on the drive in the opening direction is axially supported on a fastening surface which is rigidly connected to an armature of the drive.

In one possible configuration of the present disclosure, the closing force of the drive is also transmitted to the switch rod in the closed position of the switch via the first spring of the spring system, in particular the first spring acting on the drive in the opening direction.

In one possible configuration of the present disclosure, the switch rod and the armature of the drive are connected to each other via a freewheel arrangement, which allows relative movement of the switch rod to the armature within a freewheel region defined by the freewheel arrangement.

In one possible configuration of the present disclosure, the first spring acting on the drive in the opening direction prestresses the freewheel arrangement in the direction of a first end position of the freewheel arrangement, wherein the first end position is defined by stop areas through which the armature of the drive drives the switch rod during an opening movement.

In one possible configuration of the present disclosure, the freewheel arrangement comprises a freewheel rod which is rigidly connected to the switch rod and passes through a lifting rod of the drive, wherein a first stop area is provided at an axially outer end of the freewheel rod, which interacts with a second stop area arranged at an axially outer end of the lifting rod.

In one possible configuration of the present disclosure, a stop element rigidly connected to the switch rod is provided, which limits movement of the switch rod in the opening direction.

In one possible configuration of the present disclosure, the stop element interacts with a counter element which is supported on the housing.

In one possible configuration of the present disclosure, the stop element is sleeve-shaped and extends between the first spring and the second spring. It thus simultaneously separates the springs.

In one possible configuration of the present disclosure, an actuating element is provided which is rigidly connected to the armature of the drive and actuates a switch by means of which the position of the drive is monitored.

In one possible configuration of the present disclosure, the actuating element is arranged at an axially outer end of the lifting rod.

A nut, by means of which the actuating element is secured to the lifting rod, can serve as a stop element for the freewheel.

In one possible configuration of the present disclosure, the switching device comprises a vacuum tube.

In one possible configuration of the present disclosure, the switching element is encapsulated in the insulating housing.

In one possible configuration of the present disclosure, the insulating housing comprises insulation lamellae projecting outwardly.

By means of the vacuum tube and/or the insulation lamellae, the switch is adapted to respond to high voltages. This ensures that no voltage flashover occurs when the switch is open.

In one possible configuration of the present disclosure, the switch according to the disclosure comprises a dielectric strength of more than 1 kV, optionally a dielectric strength of more than 10 kV.

In one possible configuration of the present disclosure, the switch according to the disclosure is a medium voltage switch. In one possible configuration, the switch according to the disclosure can be used in a voltage range from 1 kV to 38 kV.

In one possible configuration of the present disclosure, the housing is cast from cast resin. For example, the switching device can be encapsulated in the housing. Furthermore, the switch bushing and/or connection contacts can also be encapsulated in the housing.

In one possible configuration of the present disclosure, the first and second springs comprise different spring rates and/or spring travel. This allows the spring system to be optimized and adjusted accordingly with regard to the required contact forces.

In one possible configuration of the present disclosure, a spring of the springs acting on the drive in the closing direction comprises a greater spring rate and/or a smaller spring travel than a spring of the springs acting on the drive in the opening direction.

In one possible configuration of the present disclosure, the switching device is actuated by a linear movement of the switch rod in the direction of its axial extension. In this case, the cavity optionally extends axially through the housing on one side of the switching device.

The drive is optionally arranged at an axial end section of the housing, but is not surrounded by it and is connected to the switching device via the switch rod, which is guided through the cavity of the housing.

In one possible configuration of the present disclosure, a freewheel rod of the drive extends at least partially through the spring acting on the drive in the direction of opening.

The drive for actuating the switch rod is optionally an electromagnetic drive.

The drive is optionally a bistable drive, for example a bistable lifting magnet.

When the present disclosure refers to a rigid connection between two elements, this simply means that the two elements are connected to each other in such a way that they cannot perform any relative movement in the axial direction during operation. However, the relative position of the two elements in the axial direction may be adjustable. Furthermore, a rotational movement of the elements relative to each other may be possible.

The present disclosure will now be explained in more detail with reference to drawings and embodiments.

### BRIEF DESCRIPTION OF THE FIGURES

The figures show in:

FIG. 1 a cross-sectional view of an embodiment of an electric switch according to the disclosure in a closed state,

FIG. 2 an enlarged cross-sectional view of a part of the embodiment of FIG. 1 in the closed state, and

FIG. 3 an enlarged cross-sectional view of a part of the embodiment of FIG. 1 in an open state.

### DETAILED DESCRIPTION

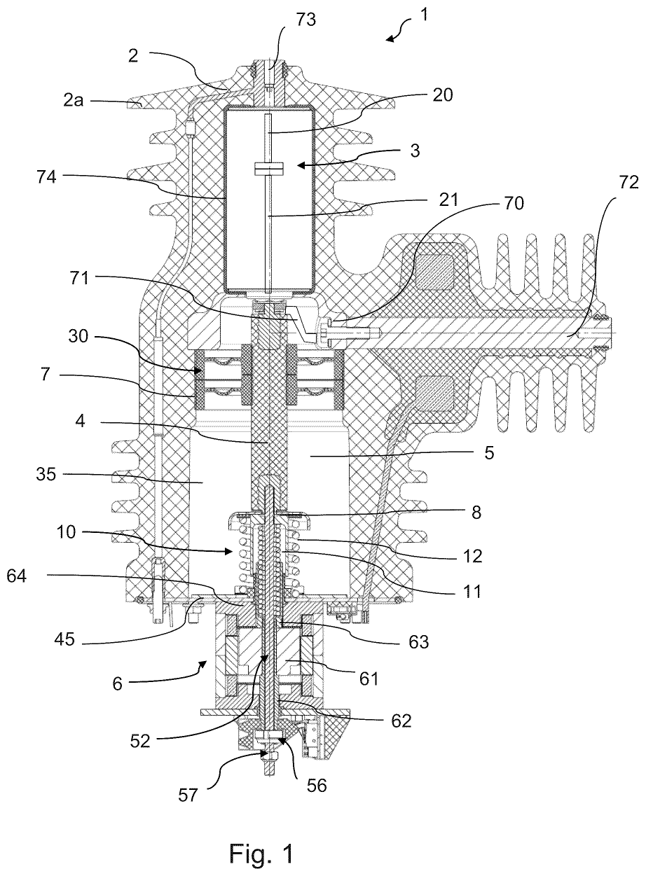

FIGS. 1 to 3 show an embodiment of an electrical switch 1 according to the disclosure with an insulating housing 2, in which several aspects of the present disclosure are realized in combination. However, the features of these aspects described on the basis of the embodiments can also be used individually.

A mechanically operable switching device 3 is arranged in the housing 2, wherein the switching device 3 can be mechanically operated by means of a switch rod 4. The switch rod 4 extends through a cavity 5 in the housing 2. Furthermore, the switch 1 comprises a drive 6, which is optionally an electromagnetic drive 6. The drive 6 serves to actuate the switch rod 4, which in turn actuates the switching device 3.

In the exemplary embodiment, the switch 1 also comprises a spring system 10, which optionally comprises a first spring 11 and a second spring 12.

In the context of the present disclosure, the term “closing direction” refers to the direction in which the switch rod 4 is moved toward the switching device in order to close it. The “opening direction”is opposite to the closing direction.

To avoid misunderstandings, it should be noted that the terms ‘inner’ and “outer” refer to the position of portions of an element in the housing or to the position of elements relative to each other in the housing. The first group of terms—inner—refers to a position that is closer to the switching device 3 in the housing than the second group of terms—outer.

In the embodiments of switch 1 shown in FIGS. 1 to 3, switching element 3 comprises a rigid contact element 20, which is rigidly connected to housing 2, and an actuable contact element 21, which can be moved toward and away from the rigid contact element 20 by means of switch rod 4. The contact elements 20, 21 are arranged opposite each other within the housing 2.

The switch rod 4 is arranged so that it can move the actuated contact element 21 into a first position, in which the actuated contact element 21 is pressed against the rigid contact element 20, and into a second position, in which the actuated contact element 21 is separated from the rigid contact element 20. In the first position, the rigid contact element 20 and the actuated contact element 21 are electrically conductively connected. This corresponds to a closed state of the switching device 3. In the second position, there is no electrically conductive connection between the rigid contact element 20 and the actuated contact element 21, which corresponds to an open state of the switching device 3.

In the exemplary embodiment, the contact elements are arranged in a vacuum tube 74 to prevent voltage breakdown.

Furthermore, as shown in FIG. 1, the electrical switch 1 may comprise a first connection contact 72, which is conductively connected to the actuated contact element 21, and a second connection contact 73, which is conductively connected to the second, optionally rigid contact element 22.

Both connection contacts 72, 73 are firmly connected to the housing 2, for example, molded into or screwed into it.

As shown in FIG. 1, the switch 1 may further comprise a switching socket 70 in which a flexible conductor strip 71 is arranged. The flexible conductor strip 71 establishes the conductive connection between the connection contact 72 leading out of the housing 2 and the actuated contact element 21.

The switching socket 70 is arranged in the housing 2 adjacent to the switching device 3, for example the vacuum tube 74.

The housing 2 is optionally cast from cast resin.

The switching device 3, for example the vacuum tube 74, and/or the switching socket 70 can be cast into the housing 2.

In particular, the connection contacts 72, 73, the switching device 3, and the switching socket 70 form a mechanical unit which is preassembled and cast in the housing 2.

Furthermore, the housing 2 may comprise insulation lamellas 2a to increase the creepage current resistance.

In the exemplary embodiment, the switching device 3 is actuated by a linear movement of the switch rod 4 in the direction of its axial extension.

The first connection contact 72 is led out of the housing 2 laterally, transversely to the axial extension of the switch rod 4.

In the exemplary embodiment, the second connection contact 73 is led out of the housing 2 on a first axial side of the switching device 3. In an alternative configuration, however, it could also be led out of the housing 2 laterally.

On the side of the switching device 3 opposite the second connection contact 73, the cavity 5 extends axially through the housing 2. The drive 6 is arranged on the side of the housing 2 opposite the second connection contact 73 at an end section of the housing 2, but is not surrounded by it and is connected to the switching device 3 via the switch rod 4, which is guided through the cavity 5 of the housing 2.

Furthermore, the embodiment shown in FIGS. 1 to 3 comprises a flexible insulating body 30, for example a diaphragm 30, which connects the switch rod 4 to an inner wall 7 of the housing 2. The insulating body 30 divides the cavity 5 of the housing 2 into an area facing the switching device 3 with respect to the insulating body 30 and an area facing away from the switching device 3 with respect to the insulating body 30, wherein both regions are electrically insulated from each other by the insulating body 30. The insulating body 30 can also serve as a seal, for example to increase the weather resistance of the switch 1.

The insulating body 30 can optionally be formed in one piece from a flexible material, optionally from an elastic insulating material such as silicone, over its radial extension. Other materials and material combinations are also conceivable for forming the insulating body 30. In the axial direction, the insulating body can be constructed from several separate elements.

The insulating body 30 comprises an outer section that is directly adjacent to the inner wall 7 of the housing 2. Furthermore, as shown in FIG. 1, the insulating body 30 may comprise a tubular inner section and a diaphragm section arranged between the outer section and the tubular inner section. As shown, the diaphragm section may have a smaller thickness than the tubular inner section and the outer section. In this case, the thickness corresponds to an extension in the axial direction. The diaphragm section extends between the outer section and the inner section.

As shown in FIG. 1, the insulating body 30 may be divided into two separate elements, each of which connects the inner wall 7 of the housing 2 to the switch rod 4.

In the exemplary embodiment, the two separate elements are axially adjacent to each other with their inner sections and outer sections, and each comprise a diaphragm section extending between the outer section and the inner section. It is also conceivable that the insulating body 30 comprises more than two separate elements. However, the insulating body could also be formed by only one of the two elements.

In the exemplary embodiment shown in FIG. 1, the tubular inner section of the insulating body 30 is pushed onto the switch rod 4 and connected to it by friction, as the diameter of the tubular inner section of the insulating body 4 is smaller than the outer diameter of the switch rod 4.

The flexible insulating body 30 is optionally connected to the inner wall 7 of the housing 2 by friction.

Here too, bonding or any other material connection is neither necessary nor intended.

The individual aspects of the present disclosure are described below on the basis of the basic structure of the switch just described. However, they can also be used in a different structure of the switch.

According to a first aspect of the present disclosure, the spring system (10) comprises a first spring (11) and a second spring (12), which are nested inside each other. Here, the first spring (11) and the second spring (12) exert a force on the drive (6) in opposite directions.

In the exemplary embodiment, the first spring (11) acts on the drive (6) in the opening direction, while the second spring (12) acts on the drive (6) in the closing direction. In other words, the first spring (11) supports the drive at least over part of the stroke when moving in the opening direction. The second spring (12) assists the drive at least over part of the stroke when moving in the closing direction.

In the figures, the opening direction corresponds to a downward direction and the closing direction corresponds to an upward direction.

In the embodiments, the two springs are each arranged concentrically with respect to the lifting rod and/or switch rod.

In the exemplary embodiment, springs 11 and 12 are coil springs. Furthermore, both springs are configured as compression springs.

In the exemplary embodiment, the first spring (11) is arranged at least partially within the second spring (12).

According to a second aspect of the present disclosure, at least part of the spring system 10 and, for example, an inner end of the two springs 11, 12 is arranged in the cavity 5 of the housing between the insulating body 30 and the axially outer end of the housing 2. The entire spring system is arranged outside the space enclosed by the insulating body 30.

The exemplary embodiment shown in FIG. 1 comprises a retaining member 45 which fixes an outer end of the spring system 10 or a part of the spring system axially within the housing. For example, the retaining member 45 fixes the outer end of the second spring 12 in the axial direction and can be fixed to the housing 2 as shown, for example by means of a screw connection. The retaining member 45 can also fix the second spring 12 in a direction transverse to the axial direction.

The retaining member 45 also fixes the drive 6 to the housing, which is arranged on the side of the retaining member 45 opposite the spring system.

In the present case, the second spring 12 of the spring system 10 extends out of the cavity 5 of the housing 2 and through a recess in the cover element 45 into an opening of the drive 6.

As shown, the retaining member 45 may be a cover element, wherein the cover element at least partially closes the cavity 5 of the housing on the side opposite the switching device 20.

The first spring 11 and the second spring 12 are supported at their end facing the switching device 3 (inner end) by a fastening arrangement 8, which is rigidly connected to the switch rod 4.

In the exemplary embodiment, the fastening arrangement 8 is configured in several parts and is fastened to the outer end of the switch rod 4.

The second spring 12 is supported at its (inner) end facing the switching device 3 on a fastening surface 8b, which is formed by a cup-shaped sheet metal element that is fastened to the switch rod 4 and on whose inner side the second spring 12 is supported.

The first spring 11 is supported at its end facing the switching device 3 (inner end) on a fastening surface 8a, which is formed by the base of a shell-shaped element 8c that is attached to the switch rod 4.

As already described above, the second spring 12 is supported at its end facing away from the switching device (outer end) on a retaining member 45 and, via this, on the housing 2.

According to a further aspect, the switch 1 comprises a freewheel arrangement via which the drive 6 is connected to the switching device 3. The freewheel is preloaded in the opening direction by the first spring 11.

When the drive 6 moves to close, the closing force is transmitted to the switch rod 4 via the first spring 11. If the contact elements 20, 21 of the switching device 3 come into contact, the drive 6 nevertheless continues to move, thereby compressing the first spring 11. The freewheel 50, the first spring 11, and the switching device 3 are formed in such a way that the force is still transmitted via the first spring 11 even in the end position of the drive 6. The freewheel 50 and the first spring 11 can therefore compensate for tolerances in the relative positioning of the switching device 3 and the drive 6, as the end position of the drive 6 and the closed position of the switching device 3 are decoupled from each other.

The first spring 11 prestresses the freewheel in the direction of a first end position, which is defined by stop areas 56, 57, through which the drive 6 drives the switch rod 4 during an opening movement.

The freewheel arrangement is formed by two freewheel elements that can move relative to each other, on which the stop areas are arranged. In the exemplary embodiment, these are the freewheel rod 52 and a guide 62 for it. A first stop area 57 is arranged on the freewheel rod 52 and interacts with a second stop area 56 arranged at one end of the guide 62.

In the exemplary embodiment, the freewheel rod 52 passes axially through a lifting rod 62 of the drive 6, which thus forms the guide for the freewheel rod 52.

A stop surface 57 arranged on the freewheel rod 52 is provided on the side of the drive facing away from the switching device 3 and interacts with a stop surface 56 provided at an end of the lifting rod 62 facing away from the switching device 3.

During a closing movement of the drive 6 of the second embodiment shown in FIGS. 1 to 3, the closing force is transmitted from the armature 61 of the drive to the switch rod 4 via the first spring 11, with the second spring 12 additionally exerting a force in the closing direction on the switch rod 4.

The first spring 11 is supported at its axially outer end on a support surface 63, which is rigidly connected to the armature 61 and the lifting rod 62.

For this purpose, the armature 61 comprises a bearing element 63 at its end facing the switching device 3, which serves to transmit force between the armature 61 and the first spring 11.

In the exemplary embodiment shown in FIGS. 1 to 3, the bearing element 63 comprises a portion facing the switch rod 4, which is configured as a hollow cylinder and in which the first spring 11 extends at least partially.

In the exemplary embodiment shown in FIGS. 1 to 3, the freewheel rod 52 passes through an opening in the fastening arrangement 8 and is rigidly connected to the switch rod 4, for example screwed into it.

The counter-stop surface 57 provided on the freewheel rod 52 can be formed on a stop element which is arranged on the freewheel rod 52 in a manner that is adjustable in its axial position. The stop element can be a nut which is screwed onto an end section of the freewheel rod 52.

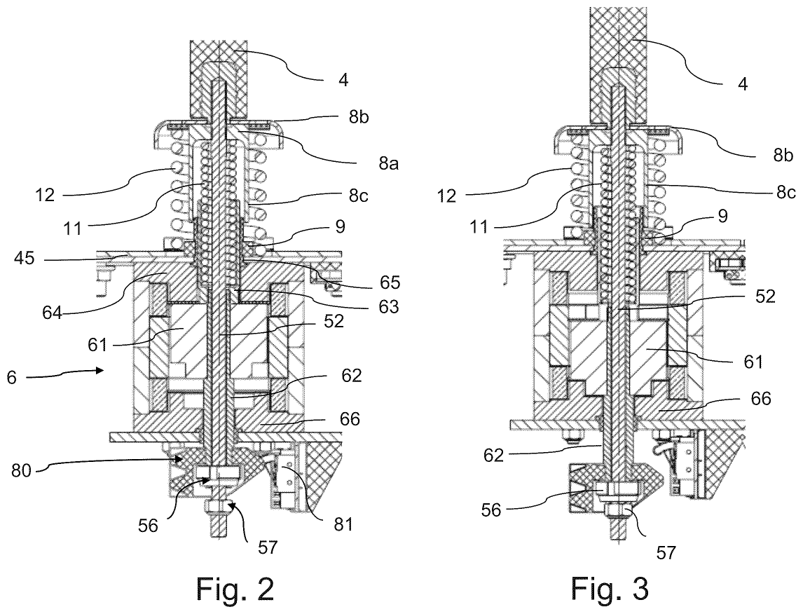

As shown in FIGS. 2 and 3, the bearing element 63 can be axially guided in a bearing bushing 65. The bearing bushing may be mounted, as shown, in an opening of the retaining member 45, which is arranged on the drive housing 64. A further bearing bushing is arranged on the side of the drive housing 66 facing away from the switching device 3 and serves to axially guide the other end of the lifting rod 62.

During an opening movement of the drive 6 of the second embodiment shown in FIGS. 1 to 3, the armature 61 of the drive 6 first moves from the position shown in FIG. 2 without driving the freewheel rod 52 with it, until the stop surface 56 of the lifting rod 62 comes into contact with the counter-stop surface 57 of the freewheel rod 52. During this phase, the opening movement of the armature 61 is supported by the first spring 11.

Once the stop surface 56 and the stop surface 57 are in contact, the stop surface 56 of the lifting rod 62 serves as a driver, via which the freewheel rod 52 and the switch rod 4 rigidly connected to it are driven and the switching device 3 is opened. During this phase, the first spring 11 can no longer support the opening movement of the armature 61, as in its end position it merely prestresses the lifting rod 62 against the freewheel rod 52.

In FIG. 3, the switch 1 is in an open state. The armature 61 is in a first end position. In FIG. 3, this corresponds to a position of the armature 61 in which it has been moved downwards and is in a lower end position. In this state, the armature 61 has brought the stop surface 56 connected to it into contact with the counter-stop surface 57, wherein the armature 61 tensions the second spring 12.

However, the switch rod 4 can continue to move toward the open position against the force of the second spring 12 beyond the position defined by the end position of the armature 61 within the drive. In this case, the counter stop surface 57 moves away from the stop surface 56.

In order to prevent the switch rod 4 from overshooting, the fastening arrangement 8 comprises a shell-shaped region 8c which extends from the switch rod towards the drive and comprises an end surface which comes into contact with a stop element 9 which is supported on the housing via the retaining member 45. This limits the stroke of the switch rod. The stop element 9 can be made of rubber, for example.

During a closing movement, the armature 61 is moved from the open state shown in FIG. 3 in the closing direction, i.e., in FIG. 3 in the upward direction, wherein in this phase the second spring 12 exerts a force in the closing direction on the armature 61.

In a predetermined position, the contact elements 20, 21 of the switching device 3 then come into contact, wherein the armature 61 nevertheless continues to move into a second end position, which in FIGS. 1 to 3 corresponds to an upper end position of the armature 61, and thereby compresses the first spring 11. In this phase, the stop surface 56 and the counter-stop surface 57 are no longer in contact, as shown, for example, in FIG. 2, and in addition, the lifting rod 62 and the freewheel rod 62 move relative to each other. The second spring 12 continues to exert a force on the switch rod 4.

The freewheel between the lifting rod 62 and the freewheel rod 52, the spring system 10, and the switching device 3 are formed in such a way that the armature 61 does not come into contact with the switch rod 4 via a rigid element such as the bearing element 63 even in its second end position corresponding to a closed position of the switch 1, Instead, the closing force of the armature 61 is applied to the switch rod 4 via the first spring 11, and optionally the second spring 12 additionally exerts a force on the switch rod 4 in the closing direction.

In the exemplary embodiment, the first spring 11 supports the drive during an opening movement from an end position corresponding to the closed position of the switch, in both cases only over part of the stroke until the freewheel is bridged.

The first and second springs 11, 12 optionally comprise different spring constants and/or spring travels.

The drive is optionally a bistable electromagnetic drive. For example, the drive can be held permanently magnetically against the force of the respective spring 11, 12 in its respective end position by means of one or more permanent magnets.

For example, a drive can be used as known from publication DE 10 2017 000 901 A1 and/or publication WO 2015/058 742 A2. Furthermore, the coordination between the spring system and the drive can also be carried out as known from these publications.

In the exemplary embodiment, the lifting rod 62 of the drive is rigidly connected to an armature 61 of the drive. The lifting rod 62 comprises a sleeve which forms the end of the lifting rod 62 facing away from the switching device and whose outer end extends out of the drive and on which the stop surface 56 is arranged.

The armature 61 is pushed onto an inner portion of the sleeve with a smaller diameter. The bearing element 63 is pushed or screwed onto the inner end of the sleeve 62 facing the switching device.

In the exemplary embodiment, an actuating element 80 is arranged at the axially outer end of the lifting rod 62, by means of which the position of the drive is monitored, in that the actuating element 80 actuates a switch 81 when moving into the closed and/or open position. Furthermore, a manual drive can engage with the actuating element 80, via which the switch can be actuated manually.

The actuating element 80 is pushed onto the axial end of the lifting rod 62 and is supported on an edge of the lifting rod 62. It is secured to the lifting rod 62 by a nut 56, which also forms the stop element for the nut 57 arranged on the freewheel rod 52, which forms the counter-stop element via which the lifting rod, when moving in the open direction, drives the freewheel rod 52 and thus the switch rod 4.

### LIST OF REFERENCE NUMERALS

1 (electrical) switch
2 (insulating) housing
2a insulation lamellae
3 switching device
4 switch rod
5 cavity of the housing
6 drive
61 armature
62 lifting rod
63 bearing element
65 bearing bushing
64, 66 drive housing
7 inner wall of the housing
8 fastening arrangement
8a, 8b fastening surfaces
8c sleeve
10 spring system
11 first spring
12 second spring
20 rigid contact element
21 actuated contact element
30 (flexible) insulating body/diaphragm
45 retaining member/cover element
52 freewheel rod
56 stop surface
57 stop surface
70 switching bushing
71 flexible conductor strip
72 connection contact
73 additional connection contact
74 vacuum tube
80 actuating element
81 switch

1. An electrical switch, comprising:
an insulating housing,
a mechanically-actuable switching device which is arranged in the housing,
a switch rod, which extends at least partially through a cavity within the housing, for actuating the switching device,
a drive for actuating the switch rod, and
a spring system,
wherein the spring system comprises a first spring and a second spring which are nested inside each other, and wherein the first spring and the second spring exert a force on the drive in opposite directions.

2. The electrical switch according to claim 1, wherein the first spring acting on the drive in an opening direction is at least partially arranged within the second spring acting on the drive in a closing direction.

3. An electrical switch, comprising:
an insulating housing,
a mechanically-actuable switching device arranged in the housing,
a switch rod which extends at least partially through a cavity within the housing for actuating the switching device,
a flexible insulating body, which connects the switch rod to an inner wall of the housing,
a drive for actuating the switch rod, and
a spring system,
wherein the spring system is at least partially arranged in the cavity of the housing.

4. The electrical switch according to claim 3, wherein the drive is arranged on an external side of a cover element which at least partially closes the cavity of the housing, wherein the spring system is arranged in a region between the cover element and the flexible insulating body.

5. The electrical switch according to claim 1, wherein an axially inner end of the first spring and/or the second spring is axially supported on one or more fastening surfaces which are rigidly connected to the switch rod.

6. The electrical switch according to claim 2, wherein an axially outer end of the second spring acting on the drive acting in the closing direction is axially supported on the housing.

7. The electrical switch according to claim 2, wherein an axially outer end of the first spring acting on the drive in the opening direction is axially supported on a fastening surface which is rigidly connected to an armature of the drive.

8. The electrical switch according to claim 2, wherein the closing force of the drive is also transmitted to the switch rod via the first spring of the spring system.

9. The electrical switch according to claim 1, wherein the switch rod and an armature of the drive are connected to each other via a freewheel arrangement which allows relative movement of the switch rod to the armature within a freewheel region defined by the freewheel arrangement.

10. The electrical switch according to claim 9, wherein the first spring acting on the drive in the opening direction prestresses the freewheel arrangement in the direction of a first end position of the freewheel arrangement, and wherein the first end position is defined by stop areas through which the armature of the drive carries the switch rod during an opening movement.

11. The electrical switch according to claim 9, wherein the freewheel arrangement comprises a freewheel rod which is rigidly connected to the switch rod is rigidly connected and passes through a lifting rod of the drive, wherein a first stop area is provided at an axially outer end of the freewheel rod, which cooperates with a second stop area arranged at an axially outer end of the lifting rod.

12. The electrical switch according to claim 9, comprising a stop element rigidly connected to the switch rod, which limits movement of the switch rod in the opening direction.

13. The electrical switch according to claim 1, comprising an actuating element which is rigidly connected to an armature of the drive and actuates a switch by means of which the position of the drive is monitored.

14. The electrical switch according to claim 1, wherein the first spring and second spring comprise different spring rates and/or spring travel.

15. The electrical switch according to claim 1, wherein the switching device comprises a vacuum tube and/or wherein the switching device is encapsulated in the insulating housing and/or the insulating housing comprises insulation lamellae projecting outwards.

16. The electrical switch according to claim 1, wherein the electrical switch is a medium voltage switch.

17. The electrical switch according to claim 3, wherein the electrical switch is a medium voltage switch.

18. The electrical switch according to claim 3, wherein the flexible insulating body is a diaphragm.

19. The electrical switch according to claim 6, wherein the axially outer end of the second spring acting on the drive acting in the closing direction is axially supported on the housing via a retaining member connected to the housing.

20. The electrical switch according to claim 19, wherein the retaining member is a cover element through which the cavity of the housing is at least partially closed.
